(19) United States
(12) Patent Application Publication
(10) Pub. No.: US 2026/0031549 A1
(43) Pub. Date: Jan. 29, 2026

(54) LOW-COST ULTRA-WIDEBAND CROSS-DIPOLE RADIATING ELEMENTS AND BASE STATION ANTENNAS INCLUDING ARRAYS OF SUCH RADIATING ELEMENTS

(71) Applicant: Outdoor Wireless Networks LLC, Claremont, NC (US)

(72) Inventors: Haifeng LI, Allen, TX (US); Peter J. BISIULES, LaGrange Park, IL (US)

(21) Appl. No.: 18/998,415

(22) PCT Filed: Jul. 27, 2023
(86) PCT No.: PCT/US2023/071072

§ 371 Date: Jan. 24, 2025

Related U.S. Application Data
(60) Provisional application No. 63/395,451, filed on Aug. 5, 2022.

(51) Int. Cl. H01Q 21/26; H01Q 9/46

(52) U.S. Cl. CPC H01Q 21/26; H01Q 9/46

(57) ABSTRACT

Radiating elements comprise a feed column, a first dipole radiator that includes a first dipole arm and a second dipole arm that are connected to the feed column, and a second dipole radiator that includes a third dipole arm and a fourth dipole arm that are connected to the feed column. The feed column, the first dipole radiator and the second dipole radiator are formed as a monolithic structure.

### CROSS-REFERENCE TO RELATED APPLICATION

The present application claims priority under 35 U.S.C. § 119 to U.S. Provisional Patent Application Ser. No. 63/395,451, filed Aug. 5, 2022, the entire content of which is incorporated herein by reference.

### BACKGROUND

The present application generally relates to radio communications and, more particularly, to radiating elements for base station antennas that have ultra-wide bandwidth operating frequency bands

Cellular communications systems are well known in the art. In a typical cellular communications system, a geographic area is divided into a series of regions that are referred to as “cells,” and each cell is served by a base station. The base station may include baseband equipment, radios and base station antennas that are configured to provide two-way radio frequency (“RF”) communications with subscribers that are positioned throughout the cell. In many cases, the cell may be divided into a plurality of “sectors,” and separate base station antennas provide coverage to each of the sectors. The antennas are often mounted on a tower, with the radiation pattern (“antenna beam”) that is generated by each antenna directed outwardly to serve a respective sector. In the most common base station configuration, a cell is divided into three 120° sectors in the azimuth plane and a base station antenna is provided for each sector. In such a three-sector configuration, the antenna beams generated by each base station antenna typically have a Half Power Beamwidth (“HPBW”) in the azimuth plane of about 65° so that the antenna beams provide good coverage throughout a 120° sector. Note that herein “vertical” refers to a direction that is perpendicular to the horizontal plane that is defined by the horizon, and the azimuth plane refers to a horizontal plane that bisects the base station antenna.

Typically, each base station antenna will include one or more so-called “linear arrays” of radiating elements that includes a plurality of radiating elements that are arranged in a generally vertically-extending column when the antenna is mounted for use. The base station antennas may also include multi-column arrays of radiating elements that can perform active beamforming. The radiating elements used in these arrays typically are dual-polarized radiating elements that are designed to transmit and receive RF signals at two different (and orthogonal) polarizations. The use of dual-polarized radiating elements increases the capacity of a base station antenna as it allows the antenna to transmit and receive twice as many signals with only a small increase in the size of the radiating elements. Most modern base station antennas use so-called slant −/+45° polarized radiating elements that transmit/receive signals at both a −45° linear polarization and a +45° linear polarization.

In order to accommodate the increasing volume of cellular communications, new frequency bands are being made available for cellular service. Cellular operators now typically deploy multi-band base station antennas that include arrays of radiating elements that operate in different frequency bands to support service in these new frequency bands. For example, most base station antennas now include both “low-band” linear arrays of radiating elements that provide service in some or all of the 617-960 MHz frequency band and “mid-band” linear arrays of radiating elements that provide service in some or all of the 1427-2690 MHz frequency band More recently, many base station antennas include one or more arrays of “high-band” radiating elements that operate in higher frequency bands, such as some or all of the 3.3-5.8 GHz frequency band. The high-band arrays (and sometimes some of the mid-band arrays) are often implemented as multi-column arrays of radiating elements that can be configured to perform active beamforming where the shape and pointing direction of the antenna beam generated by the array can be controlled to form higher directivity antenna beams that can be electronically steered throughout the coverage area of the array (e.g., a sector). The higher directivity antenna beams can support higher throughputs.

Cellular service may be provided in various sub-bands of each of the above frequency bands. Most low-band radiating elements are designed to operate across the entire low-band frequency range or a significant portion thereof (e.g., the 696-960 MHz frequency range), and most mid-band radiating elements are similarly designed to operate across the entire mid-band frequency range or a significant portion thereof (e.g., the 1695-2690 MHz frequency range). That way, the same antennas may be used in different countries (as different countries sometimes use different sub-bands) and/or to support service in multiple sub-bands (either simultaneously, if the array includes diplexers, or one sub-band at a time). However, given the large bandwidth of the 3.3-5.8 GHz high-band frequency range, it may be difficult to provide radiating elements that can operate across all or even most of the 3.3-5.8 GHz band, and hence separate arrays may be provided for different portions of the high-band frequency range (e.g., a first array that operates in the 3.3-4.1 GHz frequency band, and a second array that operates in the 5.1-5.8 GHz frequency band. However, as the number of radiating element arrays included in an antenna increases, the size of the antenna necessarily increases, which increases both cost and wind loading (which may require sturdier antenna towers), may violate local zoning ordinances, and may generally be unsightly.

### SUMMARY

Pursuant to embodiments of the present invention, radiating elements are provided that comprise a feed column, a first dipole radiator that includes a first dipole arm and a second dipole arm that are connected to the feed column, and a second dipole radiator that includes a third dipole arm and a fourth dipole arm that are connected to the feed column. The feed column, the first dipole radiator and the second dipole radiator are formed as a monolithic structure.

In some embodiments, the monolithic structure is a bent sheet metal structure.

In some embodiments, the radiating element further comprises a conductive ring, wherein the conductive ring is positioned forwardly of the first and second dipole radiators and the feed column extends rearwardly from the first and second dipole radiators.

In some embodiments, the conductive ring is also part of the monolithic structure.

In some embodiments, the conductive ring includes a plurality of meandered sections.

In some embodiments, the radiating element further comprises first through fourth connecting sections that galvanically connect the conductive ring to the respective first through fourth dipole arms.

In some embodiments, the first through fourth connecting sections are also part of the monolithic structure.

In some embodiments, the feed column comprises first through fourth feed stalks that extend from and are galvanically connected to the respective first through fourth dipole arms.

In some embodiments, the conductive ring is a continuous conductive ring.

In some embodiments, each connecting section extends from a distal end of a respective one of the first through fourth dipole arms.

Pursuant to further embodiments of the present invention, cross-dipole radiating elements are provided that comprising a first dipole radiator that includes a first dipole arm and a second dipole arm, a second dipole radiator that includes a third dipole arm and a fourth dipole arm, and a conductive ring that is mounted forwardly of the first and second dipole arms by first through fourth connecting sections that galvanically connect the conductive ring to the first through fourth dipole arms. In some embodiments, the conductive ring is a continuous conductive ring.

In some embodiments, the first dipole radiator, the second dipole radiator, the first through fourth connecting sections and the conductive ring comprise a monolithic structure. In some embodiments, each connecting section extends from a distal end of a respective one of the first through fourth dipole arms.

In some embodiments, the monolithic structure is a bent sheet metal structure.

In some embodiments, the radiating element further comprises a feed column, where the conductive ring is positioned forwardly of the first and second dipole radiators and the feed column extends rearwardly from the first and second dipole radiators.

Pursuant to still further embodiments of the present invention, cross-dipole radiating elements are provided that include a feed column that includes first through fourth feed stalks and a conductive ring that is mounted forwardly of the feed column. The first through fourth feed stalks are galvanically connected to each other through the conductive ring.

In some embodiments, the radiating element further comprises a first dipole radiator that includes a first dipole arm and a second dipole arm that are connected to the feed column and a second dipole radiator that includes a third dipole arm and a fourth dipole arm that are connected to the feed column.

In some embodiments, the first through fourth feed stalks are galvanically connected to the conductive ring through the respective first through fourth dipole arms.

In some embodiments, the feed column, the first and second dipole radiators and the conductive ring are a monolithic structure.

In some embodiments, the monolithic structure is a bent sheet metal structure.

In some embodiments, the conductive ring is positioned forwardly of the first and second dipole radiators and the feed column extends rearwardly from the first and second dipole radiators. In some embodiments, the conductive ring includes a plurality of meandered sections.

In some embodiments, the radiating element further comprises first through fourth connecting sections that galvanically connect the conductive ring to the respective first through fourth dipole arms. In some embodiments, the first through fourth connecting sections are also part of the monolithic structure. In some embodiments, each connecting section extends from a distal end of a respective one of the first through fourth dipole arms.

Pursuant to yet additional embodiments of the present invention, blanks for cross-dipole radiating elements are provided that comprise a conductive ring and first through fourth dipole arms extending radially from the conductive ring.

In some embodiments, the blank is substantially planar.

In some embodiments, the blank comprises first through fourth feed stalks that extend radially outwardly from the respective first through fourth dipole arms. In some embodiments, the first through fourth dipole arms are circumferentially spaced apart from each other by 90°.

In some embodiments, the conductive ring includes a plurality of meandered sections. In some embodiments, the meandered sections extend inwardly toward an interior of the conductive ring.

Pursuant to still further embodiments of the present invention, methods of fabricating a monolithic cross-dipole radiating element are provided. Pursuant to these methods, a blank is stamped from sheet metal. Then, the blank is bent to form the monolithic cross-dipole radiating element.

In some embodiments, the blank comprises a conductive ring and first through fourth dipole arms extending radially from the conductive ring. In some embodiments, the blank is substantially planar.

### BRIEF DESCRIPTION OF THE DRAWINGS

FIGS. 1A and 1B are side perspective views of a cross-dipole radiating element according to embodiments of the present invention.

FIG. 1C is a schematic side view of the radiating element of FIG. 1A.

FIG. 1D is an enlarged front perspective view of a central portion of the cross-dipole radiating element of FIGS. 1A-1C.

FIG. 1E is a front view of a blank that may be used to form the cross-dipole radiating element of FIGS. 1A-1C.

FIG. 2A is a front perspective view of a base station antenna according to embodiments of the present invention that includes a multi-column array of the cross-dipole radiating elements of FIGS. 1A-1C.

FIG. 2B is a schematic front view of the base station antenna of FIG. 2A with the radome removed.

FIGS. 3 and 4 are front views of blanks for cross-dipole radiating elements according to further embodiments of the present invention.

Herein, when multiple like elements are present they may be referred to using a two part reference number. Such elements may be referred to individually by their full reference numeral, and may be referred to collectively by the first part of their reference numeral (i.e., the part prior to the hyphen).

### DETAILED DESCRIPTION

Demand for base station antennas that include a large number of radiating element arrays (e.g., six, eight, ten, twelve or more arrays) has increased significantly. Additionally, there is also high demand for base station antennas that include multi-column beamforming antenna arrays, such as eight, sixteen or even thirty-two arrays that support massive multi-input-multi-output (“MIMO”) communications. Base station antennas that include a large number of linear arrays or multi-column beamforming arrays typically have a large number of radiating elements, often between about 50-100 radiating elements. Each radiating element can be relatively expensive, and hence in some antennas the radiating elements may be one of the primary cost driver for the antenna. Consequently, there is significant interest in low-cost, high performance radiating element designs.

Most radiating elements are designed to operate in a single, generally continuous band of frequencies. Some radiating elements are designed to operate over a fairly narrow frequency range, while other so-called “wideband” or “ultra-wideband” radiating elements are designed to operate over much larger frequency ranges. The size of the frequency range is typically measured as a percentage of the highest frequency in the operating frequency range. Thus, for example, the “size” of the operating bandwidth of a radiating element that is designed to operate in the 1695-2690 MHz frequency band is (2690-1695)/2690 or 37%. The operating frequency band of a radiating element may encompass multiple sub-bands that support different types of cellular service. In some cases, an antenna may be designed so that each linear array of radiating elements will support service in only one of the sub-bands (e.g., the sub-band in which the radio that is coupled to the antenna transmits and receives signals). In other cases, diplexers may be included in the antenna, so that multiple radios may be coupled to each array so that the array may simultaneously support service in two or more of the sub-bands.

Many base station antennas include radiating elements that include printed circuit board or diecast based radiating elements. However, in order to reduce dielectric losses, more expensive RF printed circuit boards are used in printed circuit board-based radiating elements, and diecast radiating elements are also expensive to manufacture. As such, the use of these radiating elements increases the cost of a base station antenna, particularly when multi-column arrays of such radiating elements are used.

Pursuant to embodiments of the present invention, low-cost cross-dipole radiating elements are provided that can be formed from sheet metal. In some embodiments, the entire radiating element may be formed from a single stamped piece of sheet metal that is bent to form the cross-dipole radiating element. Sheet metal (e.g., steel or aluminum) is much less expensive than RF printed circuit boards or die cast structures, and hence the radiating elements according to embodiments of the present invention may have significantly reduced material costs as compared to many conventional radiating elements. Moreover, since each radiating element can be formed as a monolithic structure simply by appropriately bending a piece of stamped sheet metal, the fabrication costs may also be significantly reduced, as there is no need to assemble separate pieces together or to make electrical connections (e.g., solder joints) between separate pieces. In addition, the radiating elements according to embodiments of the present invention may include features that support very large operating bandwidths, such as operating bandwidths of 34% or more. Base station antennas that include radiating elements according to embodiments of the present invention may be used, for example, as sector antennas in the above-described cellular communications systems.

Pursuant to additional embodiments of the present invention, base station antennas are provided that include a reflector and one or more arrays of radiating elements (linear arrays and/or multi-column arrays) that extend forwardly from the reflector. At least some of the arrays may be formed using the radiating elements according to embodiments of the present invention.

In some embodiments of the present invention, cross-dipole radiating elements are provided that include a feed column, a first dipole radiator that includes first and second dipole arms that are each connected to the feed column and a second dipole radiator that includes third and fourth dipole arms that are also connected to the feed column. The feed column and the first and second dipole radiators are formed as a single monolithic structure. In some embodiments, the radiating element may further include a conductive ring that is also part of the single monolithic structure.

In other embodiments, cross-dipole radiating elements are provided that include a first dipole radiator that includes a first dipole arm and a second dipole arm, a second dipole radiator that includes a third dipole arm and a fourth dipole arm, and a conductive ring that is mounted forwardly of the first and second dipole arms by first through fourth connecting sections that galvanically connect the conductive ring to the first through fourth dipole arms.

In other embodiments, cross-dipole radiating elements are provided that include a feed column that includes first through fourth feed stalks and a conductive ring that is mounted forwardly of the feed column, where the first through fourth feed stalks are galvanically connected to each other through the conductive ring.

Pursuant to still further aspects of the present invention, blanks for forming the above-described radiating elements are provided, as are related methods of fabricating radiating elements.

Embodiments of the present invention will now be described in further detail with reference to the attached figures.

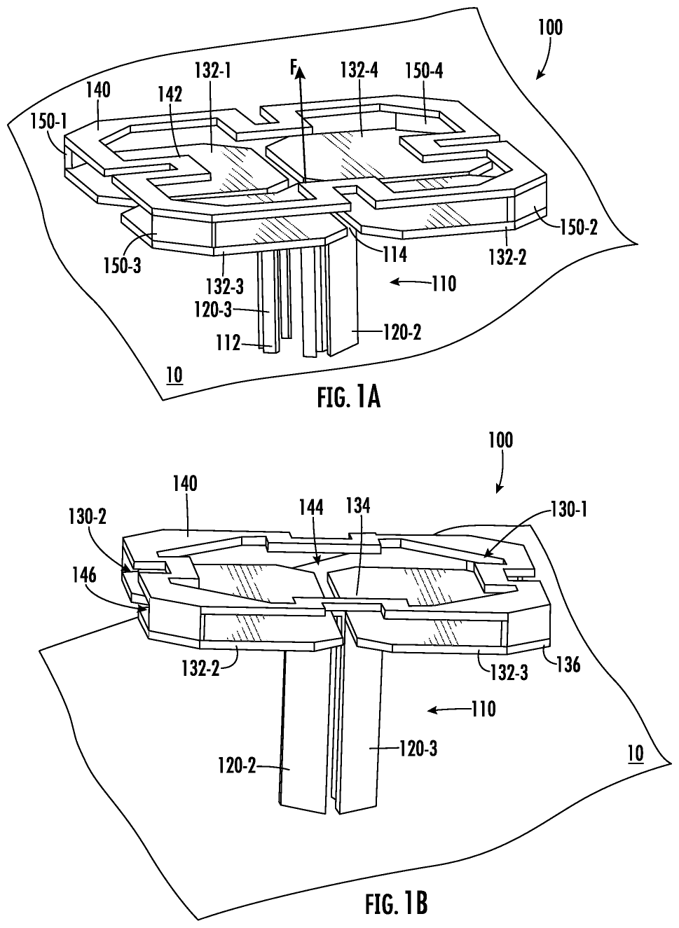

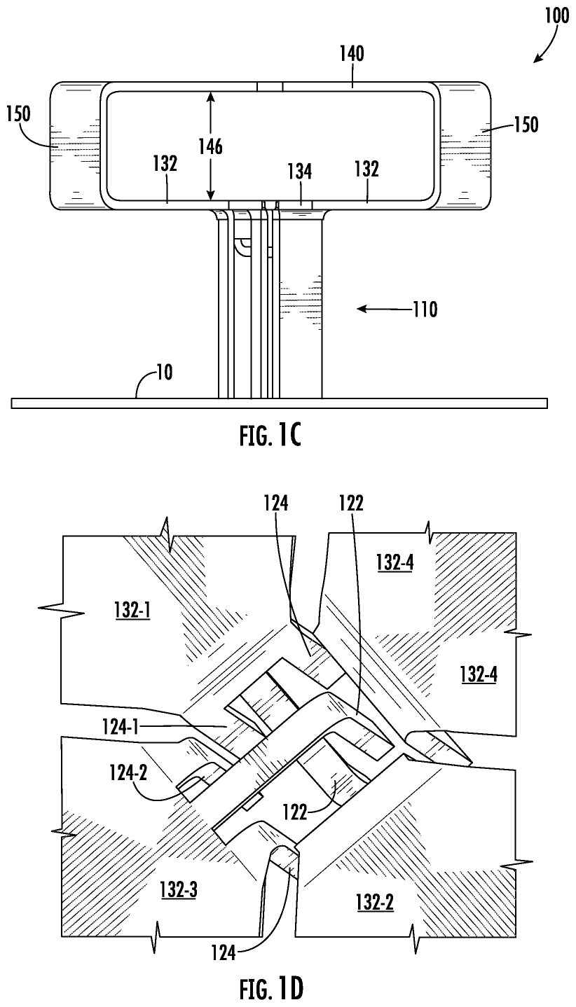

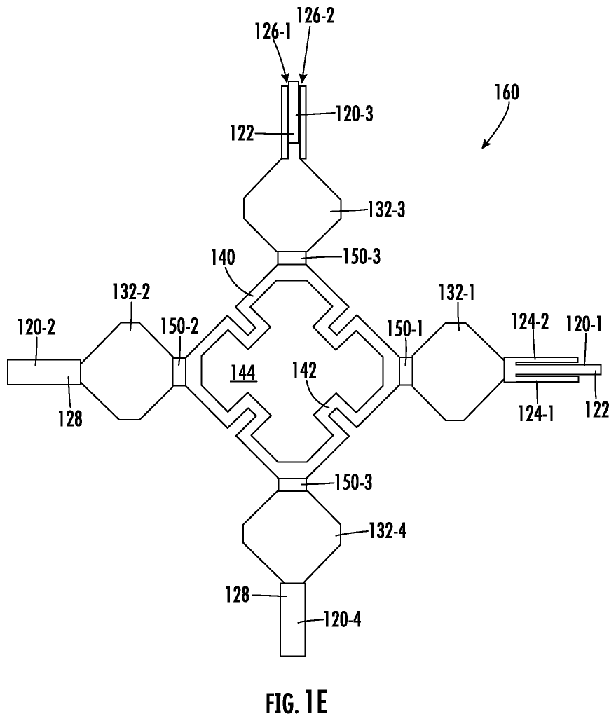

FIGS. 1A-1D illustrate a cross-dipole radiating element 100 according to certain embodiments of the present invention. In particular, FIGS. 1A and 1B are two different side perspective views of the cross-dipole radiating element 100. FIG. 1C is a schematic side view of the cross-dipole radiating element 100, and FIG. 1D is an enlarged front perspective view of a central portion of the cross-dipole radiating element 100. The cross-dipole radiating element 100 of FIGS. 1A-1D is a monolithic structure that may be formed from a single piece of sheet metal. However, in FIG. 1A, different elements of the cross-dipole radiating element 100 are illustrated with different colors (or cross-hatching) in order to better show the structural design of the radiating element 100. It will be appreciated that the different colors (or cross-hatching) in FIG. 1A is not showing separate pieces of the radiating element 100, but instead is provided merely to indicate the different elements included in the monolithic structure. These elements, and the functions that they perform, are described in greater detail below.

As shown in FIGS. 1A-1B, the cross-dipole radiating element 100 includes a feed column 110, first and second dipole radiators 130-1, 130-2, a conductive ring 140, and a plurality of connecting sections 150-1 through 150-4. A base 112 of the feed stalk 110 may be mounted, for example, on a feed board printed circuit board 10. The first and second dipole radiators 130-1, 130-2 may be integrally attached to a distal end 114 of the feed column 110. When the cross-dipole radiating element 100 is mounted for normal use, the feed board printed circuit board 10 will typically be mounted on a vertically-extending reflector (not shown), and the feed column 110 will extend forwardly (or outwardly) from the feed board printed circuit board 10. The conductive ring 140 is mounted forwardly of the dipole radiators 130-1, 130-2. The connecting sections 150-1 through 150-4 are used to mount the conductive ring 140 forwardly of the dipole radiators 130-1, 130-2. The forward direction F is illustrated by an arrow As in FIG. 1A, and may extend parallel to a longitudinal axis of the feed column 110 in the direction from the base 112 toward the distal end 114 of the feed column 110.

In the illustrated embodiment, the feed column 110 comprises four feed stalks 120-1 through 120-4. Feed stalks 120-1 and 120-3 may each comprise a flat strip of metal that has a pair of longitudinally extending slits 126-1, 126-2 formed therein. These slits 126 divide the flat strip of metal into a central strip 122 and a pair of ground strips 124-1, 124-2 that are on opposed sides of the central strip 122. As will be discussed in greater detail below, each central strip 122 may be connected to a respective feed trace (not shown) on the feed board printed circuit board 10, while the ground strips 124 may be connected to a ground plane (not shown) of the feed board printed circuit board 10. Feed stalks 120-2 and 120-4 may each comprise a flat strip of metal. Feed stalks 120-2 and 120-4, however, do not include the longitudinally extending slits 126-1, 126-2, and hence each feed stalk 120-2, 120-4 comprises a single enlarged ground strip 128. As will be discussed in greater detail below, the enlarged ground strips 128 may be connected to a ground plane of the feed board printed circuit board 10.

The dipole radiators 130-1, 130-2 are mounted on the distal end 114 of the feed column 110. Dipole radiator 130-1 comprises first and second dipole arms 132-1, 132-2, which each extend at an angle of −45° when the radiating element 100 is mounted for use and hence transmit and receive RF energy having a −45° linear polarization. Dipole radiator 130-2 comprises third and fourth dipole arms 132-3, 132-4, which each extend at an angle of +45° when the radiating element 100 is mounted for use and hence transmit and receive RF energy having a +45° linear polarization. The dipole arms 132 of each pair of dipole arms 132-1, 132-2; 132-3, 132-4 that form the respective dipole radiators 130-1, 130-2 are center-fed with RF signals from the feed column 110.

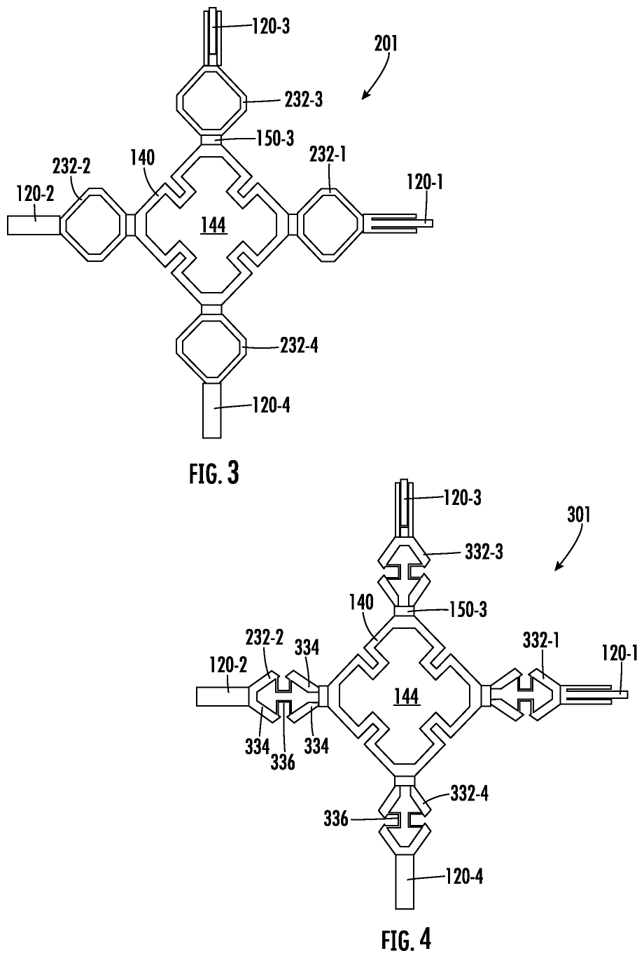

Each dipole arm 132 includes a base 134 that connects to the feed column 110 of and a distal end 136. In the depicted embodiment, each dipole arm 132 has a square shape, where corners of the square are truncated (so that each dipole arm 132 has an irregular octagon shape). However, it will be appreciated that the dipole arms 132 may have a wide variety of different shapes. Other examples of shapes are shown in FIGS. 3-4 herein.

The bases 134 of dipole arms 132-1 through 132-4 are physically and electrically connected to a distal end of respective ones of the feed stalks 120-1 through 120-4. Thus, one dipole arm 132 of each dipole radiator 130 is connected to a feed stalk 120 that has a central strip 122 and a pair of ground strips 124-1, 124-2 and the other dipole arm 132 of each dipole radiator 130 is connected to a feed stalk 120 that has single enlarged ground strip 128. The manner in which the feed stalk 120 is connected to the dipole arms 132 will be discussed in greater detail below with reference to FIG. 1D.

The conductive ring 140 is mounted forwardly of the dipole arms 132 via the connecting sections 150-1 through 150-4. Each connecting section 150 may comprise a metal stub that extends between a dipole arm 132 and the conductive ring 140. In the depicted embodiment, each connecting section 150 extends from a distal end 136 of a respective one of the dipole arms 132, but embodiments of the present invention are not limited thereto. Moreover, while one connecting section 150 is provided per dipole arm 132, it will be appreciated that in other embodiments different numbers of connection sections 150 may be provided per dipole arm 132 (e.g., two or three). Each connecting section 150 physically and electrically (galvanically) connects a respective one of the dipole arms 132 to the conductive ring 140. The extent of the connecting sections 150 in the forward direction determines the size of the respective gaps 146 that separate each dipole arm 132 from the conductive ring 140. All four gaps 146 may have the same size. The size of the gaps 146 may be selected based on the operating frequency band of the cross-dipole radiating element 100. In example embodiments, each gap 146 may be less than about 1/16^{th} of a wavelength corresponding of a center frequency of the operating frequency band of the cross-dipole radiating element 100. Keeping the gap smaller than about 1/16^{th} of a wavelength may facilitate impedance matching. Making the gap smaller than about 1/16^{th} of a wavelength may further improve the impedance match, but may degrade isolation. The size of the gap may be selected based on impedance matching and isolation considerations.

In the depicted embodiment, the conductive ring 140 has a generally square shape with truncated corners. The conductive ring 140 may comprise, for example, a piece of metal that has a generally constant width W (see FIG. 1E) that extends substantially or completely around a perimeter. A central opening 144 is defined within the interior of the conductive ring 140 where no metal is provided. In the depicted embodiment, the conductive ring 140 includes a plurality of “meandered sections” 142 which have, for example, a U-shape when the radiating element 100 is viewed from the front. These meandered sections 142 may be provided to adjust the phase of currents that are induced on the conductive ring 140 when the dipole arms 132 are excited with RF feed signals (or when receiving RF signals). The meandered sections 142 increase the length of the current path around the conductive ring 140 to provide this phase adjustment. It will be appreciated that the meandered sections 142 may have a wide variety of shapes other than U-shapes such as, for example, semicircular shapes, half oval shapes and the like. It will also be appreciated that the meandered sections 142 need not be in the same plane as the rest of the conductive ring 140. For example, the meandered sections 142 may be bent 45° or 90° to extend forwardly from the remainder of the conductive ring 140 in other embodiments.

The conductive ring 140 may act to increase the operating bandwidth of cross-dipole radiating element 100. In other words, by providing the conductive ring 140, the operating bandwidth of radiating element 100 may be increased as compared to an otherwise identical radiating element that did not include a conductive ring 140. The conductive ring 140 may effectively enlarge the electrical size of each dipole arm 132, particularly when the radiating element 100 is fed RF signals in the lower portion of the operating frequency band. Thus, at these lower frequencies, the combination of the dipole arms 132 and the conductive ring 140 tend to be resonant. At higher frequencies in the operating frequency band, the dipole arms 132 may tend to be resonant as stand-alone structures. Thus, the conductive ring 140 helps extend the bandwidth over which the dipole radiators 130 may be resonant, thereby extending the operating bandwidth of radiating element 100. Thus, the conductive ring 140 may effectively increase the overall size of the radiating element 100, but does so without increasing the “footprint” of the radiating element 100 (i.e., the projection of the radiating element 100 onto the reflector when the radiating element 100 is viewed from the front).

The conductive ring 140 may “overlap” the dipole arms 132. Herein, a first element of a radiating element “overlaps” a second element of the radiating element if, when the radiating element is mounted in front of a reflector for normal use, an axis that is perpendicular to the reflector intersects both elements. Moreover, an outer perimeter of the conductive ring 140 may substantially match an outer perimeter defined by the combination of the four dipole arms 132, as can best be seen in FIGS. 1A-1B. In the depicted embodiment, these two outer perimeters may be identical except at the locations of the meandered sections 142.

While in the depicted embodiment the conductive ring 140 is a continuous (unbroken) ring, it will be appreciated that in other embodiments one or more gaps may be provided in the conductive ring 140. Of course, if more than one gap is provided in conductive ring 140, then the cross-dipole radiating element may comprise two or more separate pieces.

FIG. 1D is an enlarged front perspective view of a central portion of the cross-dipole radiating element 100 that illustrates the connections between the feed column 110 and the dipole radiators 130-1, 130-2. Referring first to FIGS. 1A-1B, it can be seen that the enlarged ground strip 128 that forms feed stalk 120-2 extends rearwardly from dipole arm 132-2 at an angle of 90°. Referring to FIG. 1D, the distal end of central strip 122 of feed stalk 120-1 extends rearwardly at an angle of 90° for a small distance and then, is bent 900 again to extend toward dipole arm 132-2 and feed stalk 120-2. The central strip 122 of feed stalk 120-1 is then bent rearwardly again by 90° just before it contacts feed stalk 120-2, which allows the remainder of central strip 122 of feed stalk 120-1 to extend rearwardly in parallel to feed stalk 120-2, forming a first air microstrip transmission line. The ground strips 124-1, 124-2 of feed stalk 120-1 extend rearwardly from dipole arm 132-1 at angles of 90°.

The distal end of central strip 122 of feed stalk 120-3 extends toward dipole arm 132-4 and feed stalk 120-4 to cross over (in front of) the central strip 122 of feed stalk 122-1, and then experiences a bend of 90° to extend rearwardly just before it contacts feed stalk 120-4, which allows the remainder of central strip 122 of feed stalk 120-3 to extend rearwardly in parallel to feed stalk 120-4, forming a second air microstrip transmission line. The ground strips 124-1, 124-2 of feed stalk 120-3 extend rearwardly from dipole arm 132-3 at angles of 90°.

The ground strips 124-1, 124-2 of feed stalks 120-1, 120-3 may, for example, be soldered to the feedboard printed circuit board 10 and may be electrically connected to a ground plane of the feedboard printed circuit board 10. The central strips 122 of feed stalks 120-1, 120-3 may, for example, be soldered to respective RF feed traces on the feedboard printed circuit board 10. In this way, a pair of RF feed signals may be passed from the feedboard printed circuit board 10 to the cross-dipole radiating element 100, with the first feed signal being carried on feed stalks 120-1, 120-2 to feed the first dipole radiator 130-1, and the second feed signal being carried on feed stalks 120-3, 120-4 to feed the second dipole radiator 130-2.

Referring next to FIG. 1E, a “blank” 160 is shown that may be used to form cross-dipole radiating element 100. The blank 160 may comprise a stamped piece of sheet metal. In other words, a planar sheet of metal such as a sheet of steel or aluminum (or alloys thereof) may be punched using a stamping press to form a flat piece of metal having the shape shown in FIG. 1E. The blank 160 may have a cruciform shape.

As shown in FIG. 1E, the conductive ring 140 forms the center of the blank 160. The connecting pieces 150-1 through 150-4 extend radially from the four corners of the conductive ring 140. The connecting pieces 150-1 through 150-4 are spaced apart from each other in the circumferential direction by 90°. The dipole arms 132-1 through 132-4 extend radially from the respective connecting pieces 150-1 through 150-4. The dipole arms 132-1 through 132-4 are likewise spaced apart from each other in the circumferential direction by 90°. The feed stalks 120-1 through 120-4 extend radially from the respective dipole arms 132-1 through 132-4. The feed stalks 120-1 through 120-4 are also spaced apart from each other in the circumferential direction by 90°.

The cross-dipole radiating element 100 may be formed from the blank 160 by bending the inner edge of each connecting section 150 downwardly at an angle of 90°. Next, the inner edge of each feed stalk 120 is bent 90° outwardly. Then, the outer edge of each connecting section 150 is bent 90° inwardly so that the dipole arms 132 are behind the conductive ring 140, and the dipole legs 120 extend rearwardly from the dipole arms 132 at angles of 90°.

As shown in FIGS. 1A-1E, the cross-dipole radiating element 100 according to some embodiments of the present invention includes a feed column 110, a first dipole radiator 130-1 that includes a first dipole arm 132-1 and a second dipole arm 132-2 that are each connected to the feed column 110. Radiating element 100 further includes a second dipole radiator 130-2 that includes a third dipole arm 132-3 and a fourth dipole arm 132-4 that are also connected to the feed column 110. Moreover, the feed column 110 and the first and second dipole radiators, 130-1, 130-2 are formed as a monolithic structure. This monolithic structure may be a bent sheet metal structure. In some embodiments, the radiating element further includes a conductive ring 140 that part of the monolithic structure and that is positioned forwardly of the first and second dipole radiators 130-1, 130-2. In some embodiments, the conductive ring 140 may include one or more meandered sections 142. The radiating element 100 may also include a plurality of connecting sections 150 that galvanically connect the conductive ring 140 to the respective first through fourth dipole arms 132-1 through 132-4. In some embodiments, the feed column 110 may comprise first through fourth feed stalks 120-1 through 120-4 that extend from and are galvanically connected to the respective first through fourth dipole arms 132-1 through 132-4.

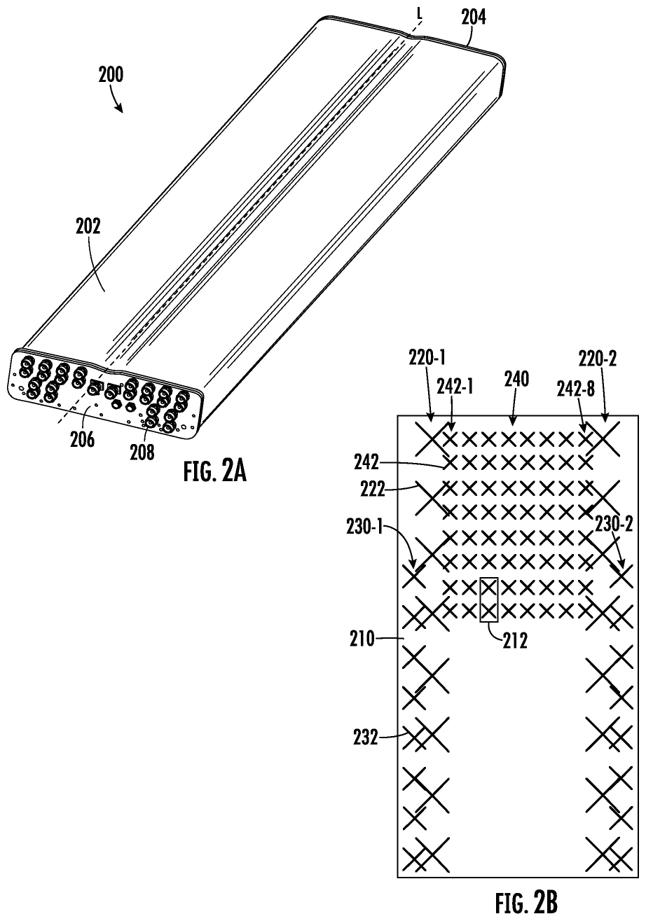

FIG. 2A is a perspective view of a base station antenna 200 according to certain embodiments of the present invention. FIG. 2B is a schematic front view of the base station antenna 200 of FIG. 2A with the radome thereof removed. In FIG. 2B, each “X” schematically represents a cross-dipole radiating element.

As shown in FIG. 2A, the base station antenna 200 is an elongated structure that extends along a longitudinal axis L. The base station antenna 200 may have a tubular shape with a generally rectangular cross-section. The base station antenna 200 includes a radome 202 and a top end cap 204. One or more mounting brackets (not shown) may be provided on the rear side of the antenna 200 which may be used to mount the antenna 200 onto an antenna mount (not shown) on, for example, an antenna tower. The antenna 200 also includes a bottom end cap 206 which includes a plurality of RF connector ports 208 mounted therein. The RF connector ports 208 may be connected to corresponding ports of one or more radios via cabling connections (not shown). In some cases, some or all of the radios may be mounted on the antenna 200 or incorporated into the antenna 200. The antenna 200 is typically mounted in a vertical configuration (i.e., the longitudinal axis L may be generally perpendicular to a plane defined by the horizon) when the antenna 200 is mounted for normal operation. The radome 202, top cap 204 and bottom cap 206 may form an external housing for the antenna 200. An antenna assembly (FIG. 2B) is contained within the housing. The antenna assembly may be slidably inserted into the radome 202.

As shown in FIG. 2B, the antenna assembly includes a reflector 210. The reflector 210 may comprise a metallic sheet that serves as a ground plane for the radiating elements (discussed below) that are mounted thereon, and also acts to redirect forwardly much of the backwardly-directed radiation emitted by these radiating elements. As is also shown in FIG. 2B, base station antenna 200 includes two low-band linear arrays 220-1, 220-2 of low-band radiating elements 222. Each low-band radiating element 222 is mounted to extend forwardly from the reflector 210, and may be configured to transmit and receive RF signals in the 617-960 MHz frequency band or a portion thereof. The base station antenna 200 further includes two mid-band linear arrays 230-1, 230-2 of mid-band radiating elements 232. Each mid-band radiating element 232 is mounted to extend forwardly from the reflector 210, and may be configured to transmit and receive RF signals in the 1427-2690 MHz frequency band or a portion thereof. The base station antenna 200 further includes a multi-column high-band array 240 that includes eight columns 242-1 through 242-8 of high-band radiating elements 244 (only columns 242-1 and 242-8 are labelled in FIG. 2B to simplify the figure). Each high-band radiating element 244 is mounted to extend forwardly from the reflector 210, and may be configured to transmit and receive RF signals in, for example, the 3.3-5.0 GHz frequency band or a portion thereof.

The radiating elements 222, 232, 244 may be mounted on feedboard printed circuit boards, with any appropriate number of radiating elements mounted on each feedboard printed circuit board (e.g., between one and thirty-two radiating elements per feedboard printed circuit board). One example feedboard printed circuit board 212 is schematically shown in FIG. 2B.

Any or all of the arrays 220, 230, 240 shown in FIG. 2B may be formed using the cross-dipole radiating elements 100 according to embodiments of the present invention (or any of the other radiating elements disclosed herein). When radiating elements according to embodiments of the present invention are used to form the radiating elements 222, 232 and/or 244 of base station antenna 200, the radiating elements may be sized appropriately to operate in the low-band, mid-band and/or high-band operating frequency bands.

FIG. 3 is a front view of a blank 201 for a cross-dipole radiating element according to further embodiments of the present invention. As can be seen by comparing FIGS. 1E and 3, the blank 201 may be identical or similar to the blank 160, except that the dipole arms 232 of blank 201 have an open interior, whereas the dipole arms 132 of blank 160 are solid pieces of sheet metal with no interior opening. The blank 201 may be bent in the same manner described above with reference to the blank 160 to form a radiating element 200. The blank 201 illustrates that the dipole arms may have a wide variety of designs. It will be appreciated that the dipole arms included in the radiating elements according to embodiments of the present invention may have any appropriate shape. It will likewise be appreciated that the design of the conductive ring 140 may be changed (e.g., the shape, the size, the width of the trace forming the ring, the shape, size and number of meandered sections (if any), etc. The designs of the feed stalks 120 may also be changed as appropriate. For example, the ground strips 124-1, 124-2 may be omitted from feed stalks 120-1 and 120-3 in other embodiments.

As described above, the radiating elements according to embodiments of the present invention may be used in multi-band base station antennas. The arrays of radiating elements included in most multi-band antennas are closely spaced in order to keep the size of the base station antenna within customer expectations. Unfortunately, the closely positioned arrays can interact with each other, which may degrade performance. One well-known type of interaction is scattering, which refers to a phenomena whereby RF energy emitted by a higher-band radiating element induces currents on the dipole arms of a nearby lower-band radiating element. These induced currents generate RF radiation that is emitted from the lower-band radiating elements. Such scattering tends to happen when the lower-band and higher-band radiating elements have operating frequency bands that include respective frequencies that differ by a factor of two.

Scattering is undesirable as it may affect the shape of the antenna beam for the higher-band radiating element in both the azimuth and elevation planes, and the effects may vary significantly with frequency, which may make it hard to compensate for these effects. Moreover, at least in the azimuth plane, scattering tends to impact the beamwidth, beam shape, pointing angle, gain and front-to-back ratio of the antenna beams in undesirable ways.

So-called “cloaking” radiating elements are known in the art that are designed to have reduced impact on the antenna beams generated by closely located radiating elements that transmit and receive signals in other frequency bands (i.e., reduced scattering). For example, U.S. Pat. No. 9,570,804 discloses a low-band radiating element that operates in the 696-960 MHz frequency band that includes dipole arms that are formed as a series of RF chokes in order to render the low-band radiating element substantially transparent to RF energy in the 1.7-2.7 GHz frequency band. U.S. Pat. No. 10,439,285 and U.S. Pat. No. 10,770,803 each disclose low-band radiating elements that operate in the 696-960 MHz frequency band that include dipole arms that are formed as a series of widened segments that are coupled by narrow inductive segments, which may be implemented as small, meandered trace segments on a printed circuit board. In each case, the narrow inductive segments act as high impedance elements for RF energy in the 1.7-2.7 GHz frequency band, rendering the low-band radiating elements substantially transparent to RF energy in that frequency range. As another example, U.S. Pat. No. 11,018,437 discloses a low-band radiating element that operates in the 696-960 MHz frequency band that includes two dipole arms that are substantially transparent to RF energy in the 1.7-2.7 GHz frequency band and another two dipole arms that are substantially transparent to RF energy in the 3.3-4.2 GHz frequency band. Additional cloaking radiating element designs are disclosed in Chinese Patent No. CN 112787061A, Chinese Patent No. CN 112164869A, Chinese Patent No. CN 112290199A, Chinese Patent No. CN 111555030A, Chinese Patent No. CN 112186333A, Chinese Patent No. CN 112186341A, Chinese Patent No. CN 112768895A, Chinese Patent No. CN 112821044A, Chinese Patent No. CN 213304351U, Chinese Patent No. CN 112421219A, and PCT Publication WO 2021/042862.

Pursuant to further embodiments of the present invention, sheet metal based radiating elements are provided that may be designed as cloaking radiating elements. FIG. 4 is a front view of a blank 301 for a cross-dipole radiating element according to still further embodiments of the present invention that includes cloaking dipole arms. As shown in FIG. 4, the blank 301 is similar to the blank 160, except that the dipole arms 332 of blank 301 are implemented as cloaking dipole arms. In particular, each dipole arm comprises a plurality of widened conductive segments 334 that are connected by narrowed conductive traces 336 that have a high impedance. As explained in U.S. Pat. No. 10,439,285, such a design allows currents in the operating frequency band of the radiating element to pass, while suppressing generation of currents in response to higher band radiation. The blank 301 may be bent in the exact same manner described above with reference to the blank 160 to form a cloaking radiating element 300. It will be appreciated that the dipole arms 332 of radiating element 300 may be replaced with a wide variety of other cloaking dipole arm designs in other embodiments.

The cross-dipole radiating elements according to embodiments of the present invention may have a number of advantages. As discussed above, the radiating elements may have very wide operating frequency bands. Simulations indicate that the radiating element 100 described above may have an operating bandwidth of 3.3-5.0 GHZ, which covers most of the high-band operating frequency band. By changing the size of the radiating element 100, radiating elements should also be available that can operate over the full low-band or full mid-band operating frequency bands. Thus, the radiating element designs discussed herein are very flexible and support the necessary operating bandwidths.

Additionally, the radiating elements disclosed herein may be manufactured at very low costs. In particular, the radiating elements may be formed of sheet metal (which is inexpensive as compared to die cast or printed circuit board based radiating elements). Moreover, each radiating element may be formed from a single piece of stamped sheet metal, which greatly simplifies the fabrication costs as the need to connect different parts of the radiating element (both physically and electrically) is avoided.

As described above, the cross-dipole radiating elements according to some embodiments of the present invention may comprise monolithic structures that comprise a single piece of bent sheet metal. It will be appreciated that additional, separate structures such as plastic support structures may be provided in conjunction with the radiating elements according to embodiments of the present invention.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A radiating element, comprising:
a feed column;
a first dipole radiator that includes a first dipole arm and a second dipole arm that are connected to the feed column; and
a second dipole radiator that includes a third dipole arm and a fourth dipole arm that are connected to the feed column,
wherein the feed column, the first dipole radiator and the second dipole radiator are formed as a monolithic structure.

2. The radiating element of claim 1, wherein the monolithic structure is a bent sheet metal structure.

3. The radiating element of claim 1, further comprising a conductive ring, wherein the conductive ring is positioned forwardly of the first and second dipole radiators and the feed column extends rearwardly from the first and second dipole radiators.

4. The radiating element of claim 3, wherein the conductive ring is also part of the monolithic structure.

5. (canceled)

6. The radiating element of claim 3, wherein the conductive ring includes a plurality of meandered sections.

7. The radiating element of claim 3, further comprising first through fourth connecting sections that galvanically connect the conductive ring to the respective first through fourth dipole arms.

8. The radiating element of claim 7, wherein the first through fourth connecting sections are also part of the monolithic structure.

9. The radiating element of claim 1, wherein the feed column comprises first through fourth feed stalks that extend from and are galvanically connected to the respective first through fourth dipole arms.

10-11. (canceled)

12. A cross-dipole radiating element, comprising:
a first dipole radiator that includes a first dipole arm and a second dipole arm;
a second dipole radiator that includes a third dipole arm and a fourth dipole arm; and
a conductive ring that is mounted forwardly of the first and second dipole arms by first through fourth connecting sections that galvanically connect the conductive ring to the first through fourth dipole arms.

13. The radiating element of claim 12, wherein the first dipole radiator, the second dipole radiator, the first through fourth connecting sections and the conductive ring comprise a monolithic structure.

14. The radiating element of claim 13, wherein the monolithic structure is a bent sheet metal structure.

15. The radiating element of claim 13, further comprising a feed column, wherein the conductive ring is positioned forwardly of the first and second dipole radiators and the feed column extends rearwardly from the first and second dipole radiators, wherein the feed column is also part of the monolithic structure.

16-17. (canceled)

18. The radiating element of claim 12, wherein the feed stalk comprises first through fourth feed stalks that extend from and are galvanically connected to the respective first through fourth dipole arms.

19. The radiating element of claim 12, wherein a perimeter of the conductive ring substantially overlaps a perimeter defined by the first through fourth dipole arms.

20. The radiating element of claim 12, wherein the first through fourth dipole arms are cloaking dipole arms.

21. The radiating element of claim 12, wherein each connecting section extends from a distal end of a respective one of the first through fourth dipole arms.

22. (canceled)

23. A cross-dipole radiating element, comprising:
a feed column that includes first through fourth feed stalks; and
a conductive ring that is mounted forwardly of the feed column,
wherein the first through fourth feed stalks are galvanically connected to each other through the conductive ring.

24. The radiating element of claim 23, further comprising:
a first dipole radiator that includes a first dipole arm and a second dipole arm that are connected to the feed column; and
a second dipole radiator that includes a third dipole arm and a fourth dipole arm that are connected to the feed column,

25. The radiating element of claim 24, wherein the first through fourth feed stalks are galvanically connected to the conductive ring through the respective first through fourth dipole arms.

26. The radiating element of claim 24, wherein the feed column, the first and second dipole radiators and the conductive ring are a monolithic bent sheet metal structure.

27-53. (canceled)
